(19) United States
(12) Patent Application Publication
(10) Pub. No.: US 2026/0065150 A1
(43) Pub. Date: Mar. 5, 2026

(54) DYNAMIC QUERYING PROCESS WITH INTEGRATED MACHINE LEARNING THROUGH SENTIMENT ANALYSIS

(71) Applicant: Optum, Inc., Minnetonka, MN (US)

(72) Inventors: Sumant RAO, Westford, MA (US); Pranit KEDARISETTY, Fremont, CA (US); Joshua BASTIAN, Orlando, FL (US)

(21) Appl. No.: 19/191,486

(22) Filed: Apr. 28, 2025

Related U.S. Application Data
(60) Provisional application No. 63/687,741, filed on Aug. 27, 2024.

(51) Int. Cl. G06N 20/00; G06F 21/60

(52) U.S. Cl. CPC G06N 20/00; G06F 21/602

(57) ABSTRACT

Various embodiments of the present disclosure provide a machine learning framework integrated within a dynamic querying process that improves the functionality of a computer in various aspects. The techniques comprise receiving a model input comprising a set of entity attributes and a set of initial query responses. The techniques comprise generating, using a machine learned model, a model prediction based on the model input and determining, based on the model prediction, an influential parameter from the first subset of independent parameters for the model prediction. The techniques comprise providing a set of subsequent queries based on the influential parameter to receive a set of subsequent query responses that correspond to a second subset of independent parameters and generating, using the machine learned model, an updated model prediction based on the model input and the set of subsequent query responses.

### CROSS REFERENCE TO RELATED APPLICATIONS

This application claims priority to U.S. Provisional Application No. 63/687,741, entitled “SYSTEMS AND METHODS THAT USE GROUP-WISE TEXT SENTIMENT ANALYSIS IN MACHINE LEARNING APPLICATIONS”, filed Aug. 27, 2024, the entirety of which is incorporated by reference herein for all purposes.

### BACKGROUND

In various domains, predictive models, such as those used in machine learning applications, may be used to generate actionable insights with respect to an entity based on input data. Such models are traditionally used to improve computer understanding by translating complex data patterns into recognizable predictions. The efficacy of predictive models within a particular domain is limited by a computer's capability of processing and interpreting diverse types of input data. This task is hindered by several technical challenges presented by data that (i) changes over time, (ii) comes from multiple different sources, (iii) contains variations in format and content, or (iv) is in a format that lacks a direct relationship to parameters of a predictive model. For example, traditionally, machine learning models are limited to numerical data and require encoders, tokenizers, or other components to transition data from an incompatible format, such as imagery, audio, or text, to a numerical equivalent. This leads to several difficulties in handling unstructured or semi-structured data, such as query responses, and limits the application of machine learning models to a set of use cases with defined correlations between the original data (e.g., the unstructured or semi-structured data) and numerical counterparts.

Predictive models also suffer performance deficiencies due to various challenges, such as data drift, presented by dynamically changing data trends. For example, traditional machine learning approaches may rely on batch processing of structured data, which may fail to capture the full complexity of rapidly changing situations. Whether batch processing, or processing in real time, the adaptability of predictive models is an ongoing concern in the field of machine learning. As the volume and variety of data continues to grow, many existing systems struggle to maintain performance and accuracy without requiring significant manual intervention or retraining. This limitation may hinder the widespread adoption and long-term effectiveness of predictive modeling in dynamic environments where data characteristics and patterns may evolve rapidly.

Another challenge faced by existing predictive models is the interpretation and utilization of domain-specific knowledge within the predictive models. Many traditional approaches use generic algorithms that may not fully leverage the nuances and contextual information relevant to specific fields of application. This may result in models that produce less accurate or less actionable predictions, particularly in specialized domains where expert knowledge plays a crucial role in decision-making processes.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a dataflow diagram of a sentiment-based prediction feedback pipeline in accordance with some embodiments of the present disclosure in accordance with some embodiments of the present disclosure.

FIG. 5 is a dataflow diagram of a data deidentification pipeline in accordance with some embodiments of the present disclosure.

FIG. 6 is a dataflow diagram of an explanatory technique for the sentiment-based prediction feedback pipeline in accordance with some embodiments of the present disclosure.

FIG. 7 is an operational example of a contribution table in accordance with some embodiments of the present disclosure.

FIG. 8 is a dataflow diagram of a model training technique for the sentiment-based prediction feedback pipeline in accordance with some embodiments of the present disclosure.

FIG. 9 is a flowchart diagram of sentiment-based prediction process in accordance with some embodiments of the present disclosure.

### DETAILED DESCRIPTION

Various embodiments of the present disclosure address the technical challenges described herein by integrating a machine learning approach within a dynamic querying process that enables active feedback and continuous improvement of the underlying machine learned model while selectively enhancing and enriching a model input through the dynamic execution of queries. To do so, some embodiments of the present disclosure provide a machine learning pipeline that combines new feature engineering, model explainability, and reinforcement training techniques within an end-to-end machine learning solution designed to improve the performance of a machine learned model with respect to a computing task. Each of the combined techniques convert a particular component of a dynamic querying process into an inference process compatible with a machine learning framework. For example, the feature engineering technique may convert a set of unstructured query responses into a numerical format that corresponds to an independent parameter of a machine learned model. In this way, the feature engineering techniques of the present disclosure enable predictive inferences that may be indirectly derived from queries provided to an entity over time, rather than solely the static data collected for the entity at a particular time. The model explainability technique enables the discovery of targeted queries for an entity by mapping up to each of the individual independent parameters of a machine learned model to a portion of a query superset. By doing so, the model explainability technique establishes a feedback loop in which parameters that may be influential to a first model prediction may be used to execute targeted queries for enhancing the accuracy of a second model prediction. The reinforcement training technique may incorporate a second feedback loop to the machine learning framework by monitoring real world data, comparing the real world data to a model prediction, and retraining the machine learned model based on data and/or performance drifts of the model. When taken together, the techniques of the present disclosure enable the seamless integration of a machine learning framework with a dynamic querying process, which, in turn, allows for several improvements to both data retrieval (e.g., by informing a retrieval process through the intelligent selection of queries) and machine learning performance (e.g., by enhancing a model input through the execution targeted queries and incorporating real world feedback).

More particularly, various embodiments of the present disclosure provide a machine learning architecture that, with the feature engineering, model explainability, and/or reinforcement training techniques of the present disclosure, improves the functionality of computer systems with respect to machine learning tasks. The machine learning architecture provides a multi-stage machine learning model that leverages a combination of static entity attributes and dynamic query responses to generate and refine predictions over time. The machine learning architecture, for example, may comprise a set of independent parameters that account for both static entity attributes and dynamic query responses. To overcome performance deficiencies with traditional machine learning models, the architecture is integrated with a dynamic query process that adapts to influential parameters identified during prediction generation. This approach enables a system, executing the model, to focus on the most relevant features for each prediction, improving accuracy while reducing computational overhead. For example, by iteratively refining predictions based on targeted subsequent queries, the system may handle complex prediction tasks more efficiently than static models.

In some embodiments, the feature engineering techniques of the present disclosure enable the integration of the machine learning architecture to the dynamic query process by mapping query responses to the independent parameters of the machine learning architecture. To do so, the feature engineering techniques may employ a combination of rule-based and machine learning-based sentiment analysis techniques to convert a query response to a numerical representation of an entity's sentiment based on the query context. This leads to improved model accuracy and extends the use cases within which machine learning models may be applied. In addition, or alternatively, the feature engineering techniques may address data security challenges in machine learning applications by implementing advanced deidentification techniques. For instance, to protect sensitive information while maintaining data utility, the feature engineering technique may employ a two-tiered deidentification approach. At a first tier, a unique token is generated for an entity. At a second tier, entity attributes may be converted to nonidentifying attribute tags allowing the model to process sensitive data without compromising entity privacy. The nonidentifying attribute tags, as well as the query responses, may be stored in association with the unique token to enable the generation of information dense model inputs without exposing the protected information underlying the model inputs. By separating the deidentification of entity identifiers and attribute-level data, the system provides a flexible framework that may adapt to varying privacy requirements across different data types.

In some embodiments, the model explainability techniques of the present disclosure improves the transparency, trust, and performance of the machine learning model by applying model explainability to a data retrieval task for supplementing model inputs. To do so, the model explainability techniques incorporate a contribution table that maps model parameters to their relative importance. The contribution table may be generated during a training phase of the machine learned model and then stored in association with the model to provide a lookup functionality of parameter importance during runtime. This feature enables the system executing the model to identify influential parameters for each prediction, providing interpretability and allowing for targeted follow-up queries. For example, by linking the contribution table to a query table, the system may automatically generate relevant subsequent queries, enhancing the model's ability to refine predictions based on the most impactful features for a preceding prediction.

In some embodiments, the reinforcement training techniques of the present disclosure address the challenges of data and model drift and ensure ongoing accuracy by defining a feedback loop for continuous model improvement. For example, the reinforcement training techniques may dynamically generate new training samples by combining real world observations with historical model inputs. By doing so, a system executing the model may adapt to changing patterns and relationships in the data over time. This self-improving mechanism allows the model to maintain its predictive power even as underlying data distributions evolve, a common issue in many real-world applications of machine learning.

Examples of technologically advantageous embodiments of the present disclosure comprise improved machine learning architectures, feature engineering techniques, model explainability techniques, reinforcement training techniques, among other aspects of the present disclosure. Individually, each of these elements improve the performance of a machine learning model and make significant advancements to the field of machine learning, data retrieval, data security, and, more generally, computer functionality. These advancements are further accomplished in combination. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

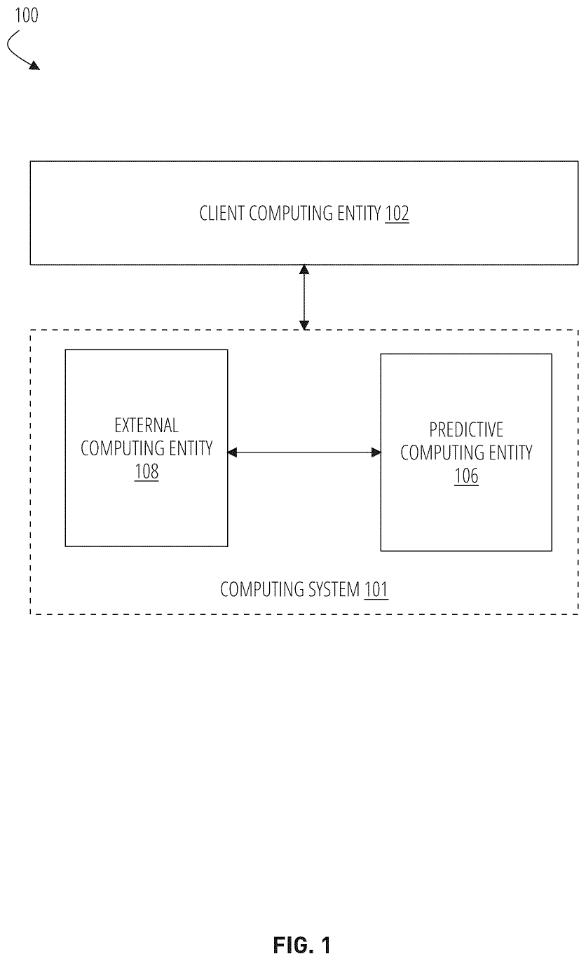

FIG. 1 is a block diagram of an example architecture 100 in accordance with some embodiments of the present disclosure. The architecture 100 comprises a computing system 101 configured to receive a request, such as a query response, model input, and/or the like, from client computing entities 102, process the request, and provide a response, such as a model prediction, query, and/or the like, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a dynamic querying process that may iteratively refined a model prediction through targeted data retrieval. Some techniques of the present disclosure may adapt traditional models, and modeling techniques, to a cohesive framework for more efficiently retrieving data and more accurately modeling a further outcome of any use case.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., model training, querying, inference techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a contribution table, a query table, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

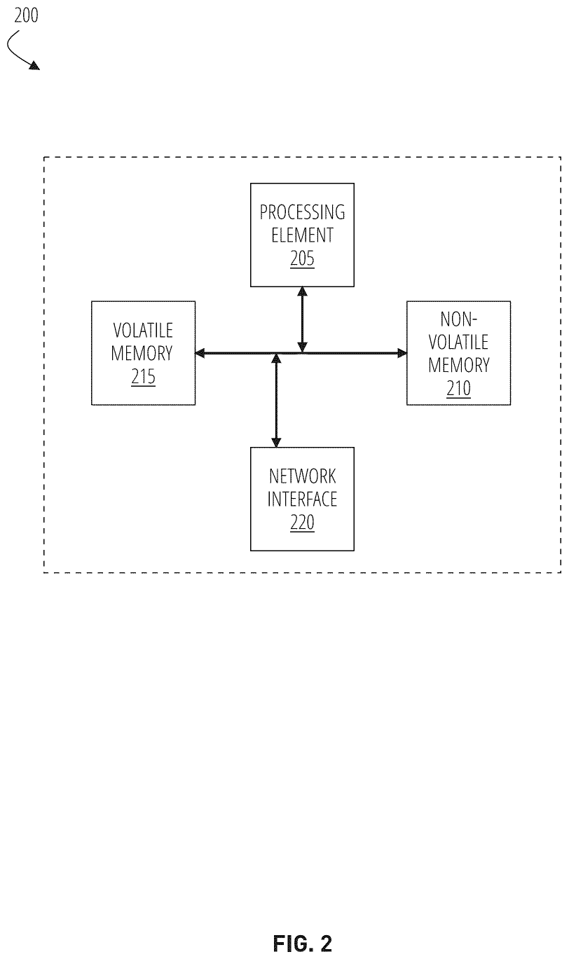

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

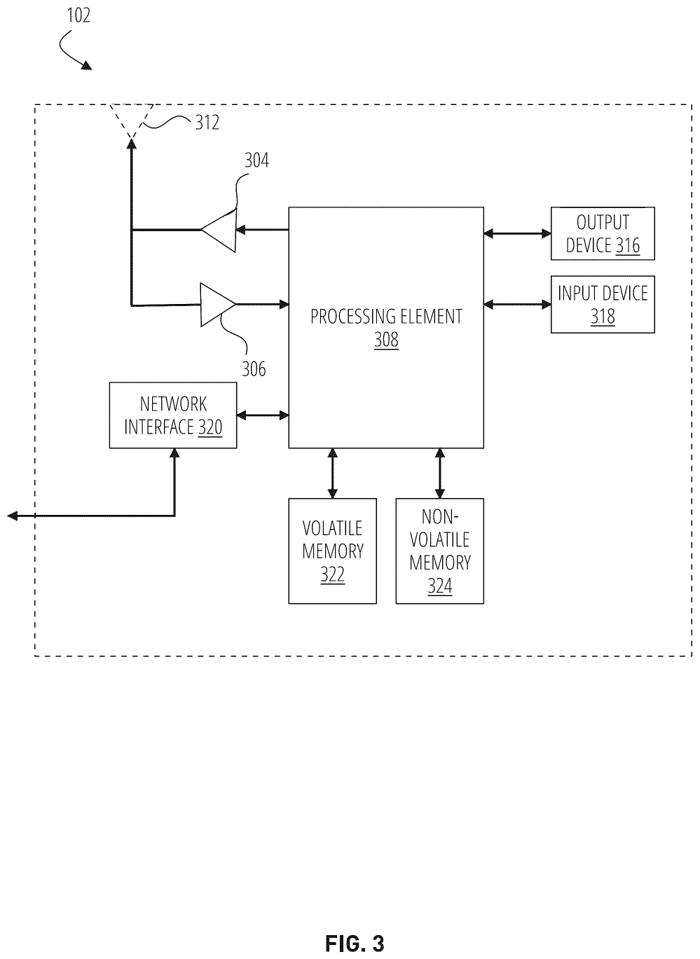

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer functionality. In particular, systems and methods are disclosed herein that implement machine learning, feature engineering, active feedback loops, among other techniques, to improve data retrieval, data storage, and machine learning inference operations. By doing so, the techniques of the present disclosure enable improved querying processes that, when executed on a computer, improves computer resource allocation. This, in turn, may improve the functionality of a computer with respect to various computing tasks, including data storage, data retrieval, machine learning training, and the like.

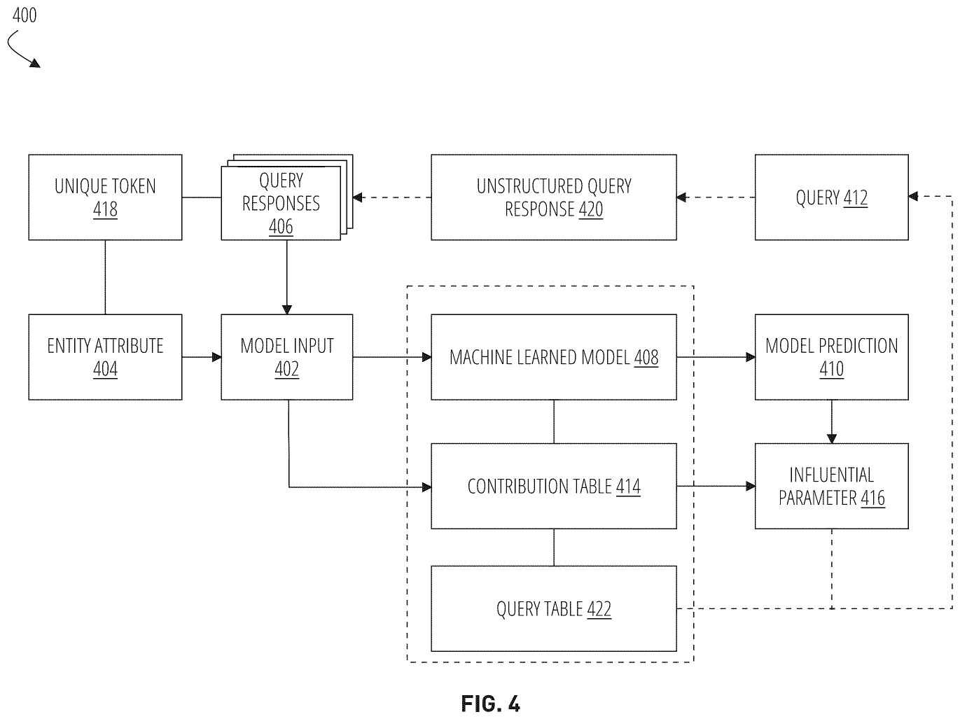

FIG. 4 is a dataflow diagram 400 of a query-based prediction feedback pipeline in accordance with some embodiments of the present disclosure. A computing system, such as the computing system 101 described herein, may implement the query-based prediction feedback pipeline to integrate a machine learning classifier into a dynamic querying process that may improve the performance of the machine learning classifier with respect to particular model input 402 over time without retraining the model. To do so, the query-based prediction feedback pipeline may combine a connected feature engineering and machine learning explanatory task with a machine learned model 408 in a cyclical prediction pipeline in which a model prediction 410 from the machine learned model 408 may be transformed into a set of queries 412 that may then provide additional feedback to the machine learned model 408 to improve the model prediction 410. More specifically, through a set of feature engineering operations, an initial set of query responses 406 may be transformed into predictive features for the machine learned model 408. The transformed features may be input, as part of an initial model input 402, to the machine learned model 408 to generate a first model prediction 410 that is derived, as least in part, from an initial set of queries 412. Through a set of model explanation operations, an influential parameter 416 may be extracted from the model input 402 and used to provide subsequent queries 412 that solicit subsequent query responses 406 for refining the model input 402. By doing so, the computing system 101 may leverage the query-based prediction feedback pipeline to iteratively augment the performance of the machine learned model 408 with respect to a model input 402 by selectively enhancing the model input 402 through a dynamic selection of queries 412.

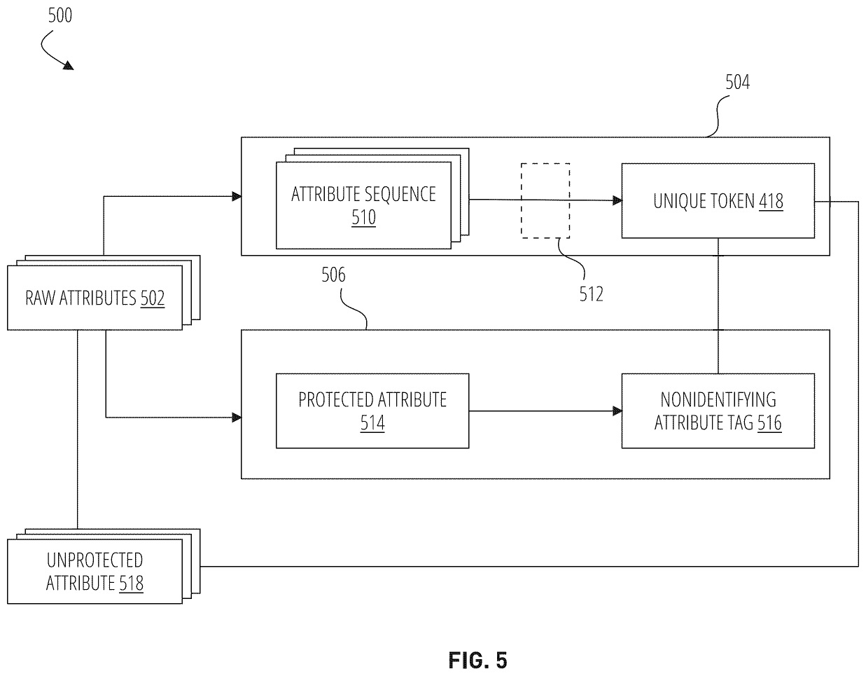

In some embodiments, the computing system 101 receives a model input 402 comprising a set of entity attributes 404 and a set of initial query responses 406. In some examples, model input 402 may be generated from a deidentified dataset aggregated for a entity from one or more different data sources. For example, as described with reference to FIG. 5, the set of entity attributes 404 and/or query responses 406 may be stored in association with a unique token 418 to deidentify the input data without reducing the predictiveness of the data.

In some examples, up to each of the components (e.g., entity attribute 404 and/or query responses 406) of the model input 402 may correspond to at least one independent parameter of a machine learned model 408. For example, the set of initial query responses 406 may correspond to (a) a set of initial queries 412 and (b) a first subset of independent parameters of a machine learned model 408. The query responses 406, for example, may map a response to a query 412 to an independent parameter of the machine learned model 408 to integrate a dynamic querying process with the machine learned model 408. Up to each of the set of initial query responses 406 may correspond to a different independent parameter of a subset of query-based independent parameters defined by the machine learned model 408. In some examples, the machine learned model 408 may merge the subset of query-based independent parameters with another subset of attribute-based parameters. By way of example, up to each of the set of entity attributes 404 may correspond to one of the subset of attribute-based parameters of the machine learned model 408.

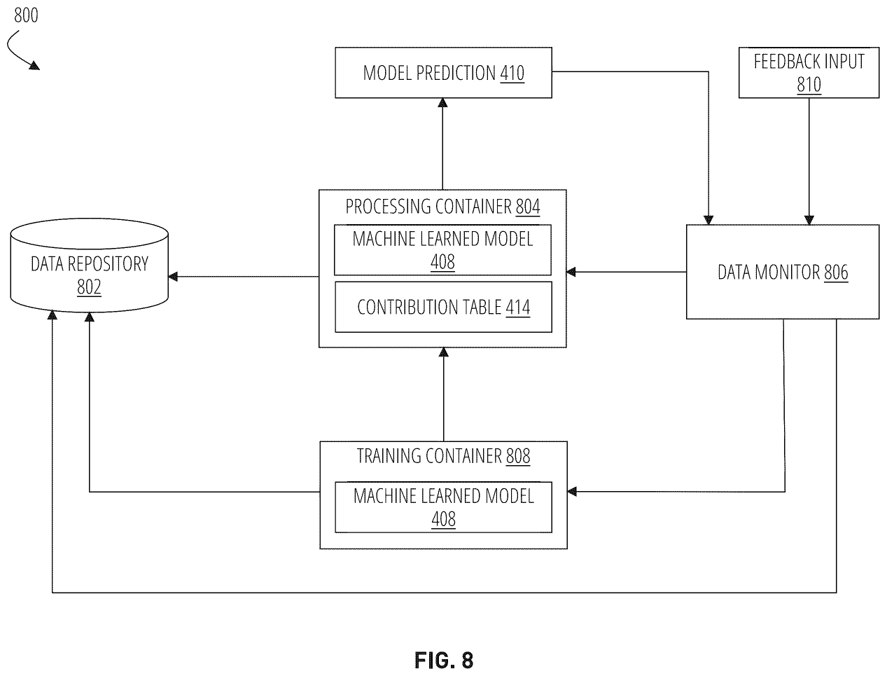

The machine learned model 408 may comprise a learned model of any machine learning architecture. For example, the machine learned model 408 may comprise a machine learning classifier, such as a neural network, random forest, and/or the like. For instance, the machine learned model 408 may comprise a random forest ensemble trained for a classification task. The random forest model, for example, may construct multiple decision trees during training and outputs the mode of the classes (for classification) or mean prediction (for regression) of the individual trees. The machine learned model 408 may be initially trained using one or more machine learning training techniques, such as back propagation of errors, using gradient descent, to maximize and/or minimize a loss function. The loss function, for example, may comprise a classification loss, such as a mean squared error, cross-entropy loss, and/or the like with respect to a dependent parameter. In some examples, as described herein with reference to FIG. 8, the machine learned model 408 may be initially trained on a set of training samples and the continuously retrained using reinforcement learning based on feedback input for the dependent parameter.

In some embodiments, the dependent parameter of the machine learned model 408 is predicted feature and/or raw output of a machine learned model 408 that is determined based on a set of independent parameters and a set of learned coefficients of the machine learned model 408. The dependent parameter may depend on the prediction domain. For example, in a clinical context, the dependent parameter may comprise a binary class indicating whether a patient will adhere (e.g., 0) or not adhere (e.g., 1) to a medication regime, a multi-class classification indicating a set of classes reflective of a set of non-adherence risks (e.g., low, medium, or high risk of non-adherence), a continuous probability score representing the likelihood of adherence, and/or the like. By way of example, in a random forest ensemble for a clinical scenario, the dependent parameter may comprise a binary PDC_classic variable, that holds a probability of adherence value. As another example, in a computer monitoring context, the dependent parameter may comprise a binary class indicating whether a computer will exceed (e.g., 0) or not exceed (e.g., 1) a processing capacity of the system, a multi-class classification indicating a set of classes reflective of a set of overload risks (e.g., low, medium, or high risk of overloading a server), a continuous probability score representing the likelihood of overload, and/or the like. By way of example, in a random forest ensemble for a computer monitoring scenario, the dependent variable may comprise a binary overload variable, that holds a probability of a computer overload.

In some examples, the dependent parameter may be represented as a single value and/or vector that encapsulates the model's raw prediction for a set of independent parameters The dependent parameter may be stored as a numerical value, a categorical label, or a probability distribution, and/or the like depending on the nature of the prediction task. In some examples, the dependent parameter may be output, using an activation function, to generate the model prediction 410 (e.g., based on a comparison to one or more classification risk thresholds).

During the training phase of the machine learned model 408, the dependent parameter may comprise the target variable that the model learns to predict based on the patterns in the independent parameters. This involves minimizing a loss function that measures the difference between the machine learned model 408 model prediction 410 and ground truths of the dependent parameter in the training samples. The specific loss function and optimization algorithm used depend on the type of machine learning task (e.g., mean squared error for regression, cross-entropy loss for classification). Once initially trained, the machine learned model 408 may generate values for the dependent parameter based on sets of independent parameters within the model input 402.

In some embodiments, the independent parameters of the machine learned model 408 define a set of predictive features that is predictive of a value for the dependent parameter. The independent parameters may comprise directly measured properties from an entity's records, such as entity attributes 404 and/or indirectly measured properties derived from an entity's responses (e.g., unstructured query responses 420) to queries 412.

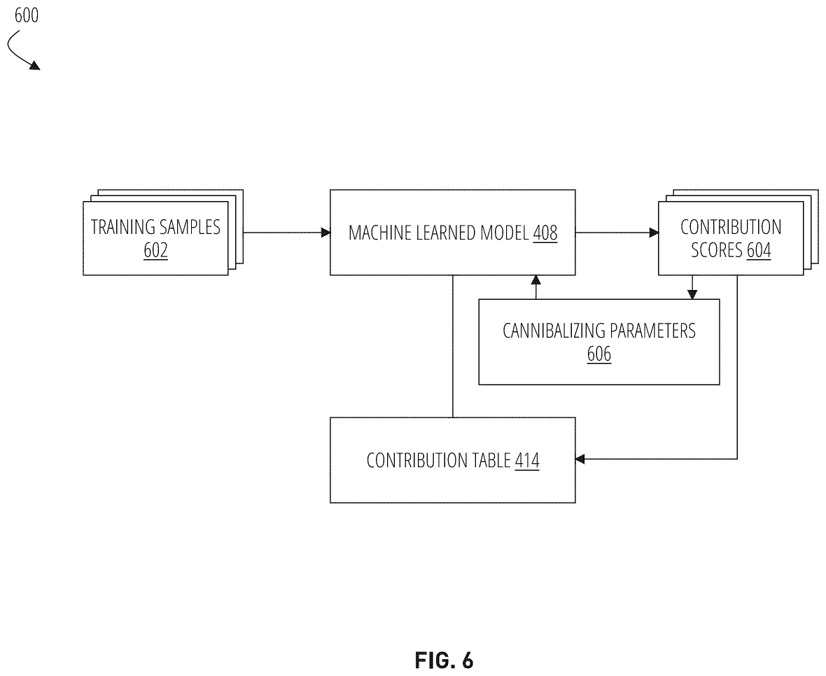

In some embodiments, the independent parameters of the machine learned model 408 comprise a set of structured parameters engineered from predictive features. For instance, the independent parameters may comprise numerical and/or categorical values that may be processed by the machine learned model 408. In some examples, raw feature values may be transformed to a structure defined by the set of independent parameters through one or more data preprocessing techniques. The data preprocessing techniques, for example, may comprise missing values and/or outlier detection, feature scaling to ensure all parameters are on a comparable scale for the model, and/or transformation operations to convert the raw predictive features to a structure defined by the independent parameter. The transformation operations, for example, may transform raw features into nonidentifying attribute tags, as described with reference to FIG. 5. In some examples, principal component analysis (PCA) and/or feature selection may be applied to reduce dimensionality and/or identify the most informative parameters, as described with reference to FIG. 6

In some examples, the independent parameters of the machine learned model 408 may serve as the basis for the model predictions 410. During the training phase, the machine learned model 408 learns the relationships between these parameters and the dependent parameter. In the prediction phase, new sets of independent parameters are fed into the model to generate model predictions 410. The relative importance of different independent parameters in making predictions may be analyzed to gain insights into the factors driving the predicted outcomes, as described with reference to FIG. 6.

In some embodiments, an initial model input 402 comprises a set of entity attributes 404 and a set of initial query responses 406 for a set of initial queries performed prior to the creation of the model input 402. The set of initial queries may comprise just a portion of a query superset such that additional queries 412 may be provided to enhance the model input 402 over time. For example, each new query, or each instance of the same query, may solicit an unstructured query response 420 from an entity. Up to each of the unstructured query responses 420 may be aggregated, according to the feature engineering task of the present disclosure, to generate new, or updated query responses 406 for a model input 402 that enhance the predictiveness of the input for the machine learned model 408. For example, each new or updated query response aggregated from one or more queries of the query superset may correspond to a different independent parameter of the machine learned model 408 such that additional or refined query responses 406 may enhance the decision points within the machine learned model 408.

In some embodiments, the model input 402 is a structured input for the machine learned model 408 that aggregates a set of entity attributes 404 and query responses 406 corresponding to the independent parameters of the model. The structured input serves as the data representation that the machine learned model 408 may use to make predictions and/or classifications.

The model input 402 may comprise a feature vector and/or matrix (e.g., where each row represents an entity and each column represents a different independent parameters). For instance, the model input 402 may be implemented as a multi-dimensional array, a data frame structure, and/or the like. The data types of the input features may vary, including numerical values (e.g., age, number of previous refills in a clinical context), categorical values (e.g., gender, medication name in a clinical context), and/or derived features (e.g., sentiment scores from survey responses).

In some embodiments, the entity attributes 404 comprise predictive features that are derived from at least one data source associated with an entity. The entity attributes 404, for example, may comprise non-protected attributes and/or deidentified protected attributes that are reflective of contextual data for the entity and stored in association with a unique token 418 to sever the direct connection between the contextual data and the entity's identity. Generally, the entity attribute 404 may comprise a static value that is recorded for an entity and/or that is not dependent on an entity's interaction with and/or to a query 412. Instead, for example, the entity attribute 404 may represent inherent or express characteristics, historical data, and/or the like of the entity. In this way, the entity attribute 404 may serve as baseline features for the machine learned model 408, providing context about the entity that complements the more dynamic information gathered from query responses 406.

In some examples, the entity attributes 404 may be defined according to a prediction domain for the machine learned model 408. For example, in a computer security embodiment, the entity attributes 404 may comprise a computer age, one or more network associations, past or present security vulnerabilities, and/or the like. As another example, in a healthcare diagnostics embodiment, the entity attributes 404 may comprise a patient's age, comorbidities, past medication adherence history, and/or the like.

In any domain, entity attributes 404 may be stored in structured data formats, such as relational databases, data warehouses, and/or the like. Each entity, for example, may correspond to a data record, one or more rows or tables in the database, a node or subgraph in a graph database, and/or the like. In some examples, to separate the entity attribute 404 from the actual identity of the entity, the data record, row, table, node, subgraph, and/or the like may group a set entity attribute 404 using a unique token 418, as described with reference to FIG. 5.

In some embodiments, the computing system 101 converts a query response 406 from an unstructured query response 420 in accordance with a feature engineering task. For example, the computing system 101 may receive an unstructured transcript that records a set of queries and/or unstructured query responses 420 to the set of queries. The computing system 101 may identify, using an natural language processing model, a query within the unstructured transcript and/or identify an unstructured query response 420 within the unstructured transcript based on a location of the query. The computing system 101 may generate, using a defined response-parameter mapping, the query response from the unstructured query response. The query response, for example, may comprise a numerical sentiment value within a sentiment range that is defined for the query, as described herein.

In some embodiments, a query 412 is one of a set of defined information prompts for an entity (e.g., a patient, a computer, a computer program, a robotic agent). For example, the query 412 may comprise a survey question used to gather information from the entity with respect to a feature that may be predictive of a dependent parameter. In the clinical context, for example, a query may be designed to elicit information about a patient's experiences, attitudes, and behaviors related to their treatment regimen. In a computer monitoring context, the query may be designed to elicit information about a computer's activity, access patterns, and/or the like related to the computer's processing capabilities.

A query 412 may be stored in a database, structured data format, lookup table, and/or the like. In some examples, the query 412 may be associated with metadata, such as its purpose, the type of response it expects (e.g., yes/no, numerical rating, free text), and the aspect of patient experience it aims to assess (e.g., side effects, understanding of treatment, quality of life). In some examples, the metadata may identify one or more independent parameters associated with the query 412. In addition, or alternatively, the query 412 may be stored in and/or referenced by a query table 422 reflective of an association between the query 412 and/or one or more parameters of the machine learned model 408.

The query 412 may comprise one of one of more different types of queries of a query superset used to gather comprehensive information. For example, the query 412 may comprise a closed-ended question with predefined response options, an open-ended question allowing free-text responses, or numerical rating scales, and/or the like. As described herein, unstructured query responses 420 solicited by such query 412 may be transformed, according to their query types, to improve the compatibility between the set of queries 412 and the machine learned model 408.

In some embodiments, a set of queries 412 may be associated with a query group of a set of domain specific query groups based on semantic relationship between the queries 412. In some examples, up to each the set of domain specific query groups may correspond to a sentiment type predictive of a dependent parameter. For example, in a clinical domain, the set of domain specific query groups may comprise groups of queries related to medication side effects, treatment efficacy, overall quality of life, and/or the like, that may be predictive of a likelihood of adhering to a medication regime. As another example, in a computer monitoring domain, the set of domain specific query groups may comprise groups of queries related to access patterns, usage rates, and/or the like, that may be predictive of a likelihood of overloading a computer system.

In some embodiments, an unstructured transcript is a medium of information that records unstructured query responses 420 to one or more of a superset of queries 412. The unstructured transcript, for example, may comprise an audio file, imagery, natural language text, such as an audio or image transcription, and/or the like, that details a query interaction between an entity and the one or more of the superset of queries 412. By way of example, the unstructured transcript may comprise a textual, video, and/or audio representation of a conversation between a patient and a healthcare provider, a patient's written responses to open-ended survey questions, and/or the like in a clinical context. In a computer monitoring context, the unstructured transcript may comprise a textual, video, and/or audio representation of a data exchange between a computing system and a monitored device, program, and/or the like.

In some examples, an unstructured transcript may be parsed, cleaned, and/or transformed to extract unstructured query responses 420 for the one or more queries 412. For example, natural language processing techniques (NLP), such as named entity recognition (NER), tokenization, syntax parsing, part-of-speech (POS) tagging, keyword extraction, rule-based matching, transformer-based phrase detection, and/or the like, may be applied to text-based transcripts to extract one or more unstructured query response 420. In addition, or alternatively, image recognition techniques, such as image-based machine learning model (e.g., convolutional networks), and/or audio recognition techniques, such as speech-to-text machine learning models, may be applied to extract the one or more unstructured query responses 420.

In some embodiments, an unstructured query response 420 is a natural language, image, or audio response to a query 412. The unstructured query response 420, for example, may comprise a text segment, image bounding box, audio snippet, and/or the like that reflect a raw, unstructured answer to a query 412. In this way, the unstructured query response 420 may represent a human interpretable response to a query 412 that is incompatible with machine learned classifier architectures. To leverage the predictive insights from the incompatible data format, the computing system 101 may apply a defined response-parameter mapping to map the unstructured query response 420 to an unstructured query response 420 that reflects at least one predictive feature of the unstructured query response 420. The defined response-parameter mapping, for example, may map the unstructured query response 420 to a numerical and/or probabilistic sentiment score that may provide a quantitative representation of an entity experience that corresponds to an independent parameter of the machine learned model 408.

More particularly, in some embodiments, the defined response-parameter mapping is a mapping between an unstructured input and an entity sentiment that may be expressed as a numerical parameter. For example, for a multi-choice query, a defined response-parameter mapping may define a sentiment score corresponding to up to each possible answer for the query. In addition, or alternatively, for open ended queries, the defined response-parameter mapping may comprise a sentiment analysis model, such as a large language model, trained to predict a sentiment underlying an unstructured query response 420.

In some examples, the defined response-parameter mapping may be implemented as a structured data object, such as a dictionary and/or lookup table. For up to each of query superset, the defined response-parameter mapping may specify a direct or indirect mapping between different response options to sentiment values. For example, for a yes/no question about experiencing side effects, a “yes” response might map to a negative sentiment value, while a “no” response maps to a positive sentiment value.

In some examples, the defined response-parameter mapping may define a set of query buckets that divide the query superset into subset of queries, each corresponding to one independent parameter of the machine learned model 408. A query bucket, for example, may correspond to a sentiment type of a set of sentiment types (e.g., in a clinical scenario an entity's sentiment with respect to stress and fatigue may be separated into different query buckets). In some examples, unstructured query responses 420 may be converted to a query response 406 by converting the unstructured query response 420 to individual query-level sentiment values and then aggregating up to each individual query-level sentiment value for up to each query within a query bucket to form query response. In this manner, query responses 406 may be generated that are reflective of a sentiment type. By doing so, the computing system 101 the query grouping facilitates more nuanced sentiment analysis and feature engineering for the machine learned model 408, while avoiding noisy features due to anomalous unstructured query response 420.

In some embodiments, the query responses 406 are a numerical sentiment values derived, using the defined response-parameter mapping, from raw responses to one or more queries 412. The computing system 101 may generate the query response 406 by preprocessing an unstructured query response, which may comprise tokenization, removing stop words, lemmatization, and/or the like. In some example, the computing system 101 may apply a sentiment analysis algorithm, such as a rule-based mapping, a pre-trained model like bidirectional encoder representation (BERT) or domain-specific models trained on domain-specific unstructured transcripts, and/or the like, to generate a numerical score within a defined range (e.g., −1 to 1, where −1 represents extremely negative sentiment and 1 represents extremely positive sentiment). In some examples, the numerical scores from up to each query within a query grouping may be aggregated to generate a query response 406.

In addition, or alternatively, a query response may a delta response that measure changes in an entity's sentiment over time. This involves comparing query responses 406 across different time points. In such a case, a current query response 406 for a model input 402 may be replaced with a delta sentiment value reflective of a delta between the current query response 406 and an immediately preceding query response 406.

In some embodiments, the computing system 101 generates, using the machine learned model 408, a model prediction 410 based on the model input 402. The model prediction 410 may comprise a dependent parameter of the machine learned model 408.

In some embodiments, the model prediction 410 to one of a set of output classes defined for the machine learned model 408, which may comprise a multi-class classification model and/or a binary classification model. The machine learned model 408 may be reflective of a different prediction depending on the prediction domain. For example, in the context of medication adherence prediction, the model prediction 410 may comprise a classification of a patient into adherence risk categories (e.g., low, medium, high risk) or a binary prediction of whether a patient is likely to adhere to their medication regimen. As another example, in a computer monitoring domain, the model prediction 410 may comprise a classification of a computer into an overload risk category (e.g., low, medium, high risk) or a binary prediction of whether a computer is likely to overload.

A model prediction 410 may comprise a classification, a probability score (e.g., for classification tasks, the model may output probability scores for up to each of a set of possible classes, indicating the model's confidence in its prediction), a confidence intervals (e.g., for regression tasks, the model may provide a range of values within which the true value is likely to fall, given a certain confidence level), a feature importance (e.g., information about which input features had the most significant impact on the prediction, which may be valuable for understanding the factors driving the predicted outcome), and/or the like.

In some embodiments, the computing system 101 determines, based on the model prediction 410, an influential parameter 416 from the first subset of independent parameters for the model prediction 410. In some examples, the computing system 101 may determine whether the model prediction 410 meets or exceeds a risk threshold.

In some embodiments, the risk thresholds comprises one of a set of thresholds used to separate a probabilistic model prediction 410 into different risk categories, such as high risk, medium risk, and/or low risk of a target prediction. These thresholds, for example, may be determined based on a combination of statistical analysis, domain expertise, operational considerations, and/or the like. The risk thresholds, for example, may comprise numerical values that serve as decision boundaries for categorizing model predictions. For example, the risk thresholds may comprise a first risk threshold (e.g., low risk: 0 to 0.3), a second risk threshold (e.g., medium risk: 0.3 to 0.7), a third risk threshold (e.g., high risk: 0.7 to 1), and/or the like.

In response to a determination that the model prediction 410 meets or exceeds the risk threshold, the computing system 101 may determine the influential parameter 416 based on a set of contribution scores defined within a contribution table 414 corresponding to the machine learned model 408. By way of example, the set of contribution scores of the contribution table 414 may be determined through a model explanation task described with reference to FIG. 6. In some examples, the contribution table 414 may correspond to a query table 422 that maps the influential parameter 416 to the set of subsequent queries 412. By way of example, the machine learned model 408, the contribution table 414, and/or query table 422 may be generated during training and/or finetuning of the machine learned model 408 and stored in association with each other.

In some embodiments, the influential parameter 416 is a parameter of the machine learned model 408 with a high feature contribution score with respect to the model input 402. The influential parameter 416, for example, may comprise one or more highest rated independent parameters from the model input 402, as defined within the contribution table 414.

The contribution table 414, for example, may comprise a data structure, such as a lookup table, that stores a set of recorded contribution scores for up to each of the independent parameters of the machine learned model 408. For instance, the contribution table 414 may serve as a reference for understanding the relative importance of different features to a model prediction 410, determined using one or more model explainability techniques as described herein.

In some embodiments, the computing system 101 provides a set of subsequent queries 412 based on the influential parameter 416 to receive a set of subsequent query responses that correspond to a second subset of independent parameters. The set of subsequent query responses, for example, may be aggregated from a set of subsequent queries selected from the query superset, as described herein. In some examples, the set of subsequent query responses may be stored as query responses 406 in association with the unique token 418.

In some embodiments, the query table 422 comprise a data structure, such as a lookup table, that links the parameters of the machine learned model 408 to the query superset. The query table 422, for example, may comprise a mapping between the machine learned model 408 internal representation and the external queries 412 used to gather input data. In this way, the query table 422 may enables the computing system 101 to dynamically execute relevant queries 412 based on the current state of the machine learned model 408 and its model predictions 410.

The query table 422 may be implemented as a database table, in-memory data structure, and/or the like, that comprises a set of data entries for up to each of the independent parameters of the machine learned model 408. The data entries, for example, may comprise model parameters, corresponding query sets, and/or metadata, such a contribution scores and/or query priorities. In some example, the computing system 101 may populate and/or maintain the query table 422 through a user feedback (e.g., reinforcement learning with human in the loop (RLHF)), automated learning initialized through random assignment, and/or the like. For example, as the machine learned model 408 evolves, machine learning techniques, such as association rule mining, clustering, and/or the like may be used to discover new parameter-query relationships automatically.

In this manner, the query table 422 may enable incremental functionality improvements in the machine learned model 408 by allowing for adaptive questioning, where the most relevant queries 412 are selected based on the current prediction and influential parameters to the current prediction. This may improve data collection efficiency and model accuracy by providing a layer of abstraction between the model internals and the input interface, allowing queries to be refined or localized without changing the underlying model structure.

In some embodiments, the computing system 101 generates, using the machine learned model 408, an updated model prediction 410 based on the model input 402 and the set of subsequent query responses 406. In this manner, the computing system 101 may integrate a machine learning pipeline with a dynamic querying process designed to selectively enhance a model input 402. By doing so, the computing system 101 may enhance the model input 402 over time based on the model predictions 410 of the machine learned model 408. This, in turn, leads to improved machine learning performance (e.g., in terms of accuracy) of the machine learned model 408, while optimizing processing and memory resources for features most predictive of a target outcome.

FIG. 5 is a dataflow diagram 500 of a data deidentification pipeline in accordance with some embodiments of the present disclosure. A computing system, such as the computing system 101 described herein, may implement the data deidentification pipeline to store data, such as the entity attributes, the set of initial query responses, the set of subsequent query responses, and/or the like, in association with a unique token 418, rather than using information directly identifying the entity, to break the direct relationship between the data and the entity associated with the data. To do so, the data deidentification pipeline may leverage a pair of deidentification rulesets to transform raw, identifying, attributes 502 into a deidentified unique token 418 and/or nonidentifying attribute tags 516. For instance, in accordance with the data deidentification pipeline, a token deidentification ruleset 504 may transform a first portion of the raw attributes 502 into the unique token 418 that may be reproducible only by parties with access to both first portion of the raw attributes 502 and the token deidentification ruleset 504. In this manner, a unique token 418 may be generated and shared across platforms without exposing the underlying information to adverse parties. In addition, or alternatively, in accordance with the data deidentification pipeline, a tag deidentification ruleset 506 may transform protected attributes 514 of the raw attributes 502 into nonidentifying attribute tags 516 that preserve the predictiveness of the protected attribute 514 without exposing the underlying information to adverse parties. In this way, the computing system 101 may execute the data deidentification pipeline to store, maintain, and use predictive features for an entity without exposing the entity's underlying protected information.

In some embodiments, the computing system 101 receives set of raw attributes 502 for the entity. The set of raw attributes 502 may comprise a subset of protected attributes 514 and/or a subset of unprotected attributes 518. In some embodiments, the raw entity attribute 404 is an unprocessed attribute that may expose protected information for an entity. These are the original, unaltered data points collected about an entity, which may comprise sensitive or unsensitive information, as defined for a particular domain.

In some embodiments, a protected attribute 514 is a raw entity attribute 404 that is protected by a data security scheme. The data security scheme may depend on the prediction domain. For example, in a clinical context, the data security scheme may comprise HIPAA guidelines that define sensitive personal and/or health-related data points (e.g., direct identifiers, such as names, social security numbers, or medical record numbers, as well as quasi-identifiers, such as zip codes, dates of service, or rare diagnoses) that require special handling to ensure privacy and compliance with regulatory requirements. As another example, in a computer monitoring context, the data security scheme may comprise general data protection regulations (GDPR), and/or the like.

In some examples, protected attributes may be subject to security measures. The security measures, for example, may comprise encryption (e.g., at rest and/or in transit), access controls, audit logging, and/or the like, to track all interactions with the protected data. In some examples, the computing system 101 may employ one or more deidentification rulesets to enable the aggregated storage of such data in compliance with the security measures. For example, as described herein, the deidentification rulesets may employ specific data masking, tokenization, and/or other techniques to protect the data underlying a protected attribute. Unlike tradition techniques, such as excluding protected attributes entirely from a machine learned model 408, using them only in aggregate form, employing privacy-preserving machine learning techniques, such as differential privacy, the deidentification rulesets may uniquely mask data in controlled manner that protects the data without reducing its predictiveness.

In some embodiments, the unprotected attribute 518 is an attribute that is not protected by a data security scheme. These are typically less sensitive data points that do not require the same level of privacy protection as protected attributes 514. As such, unprotected attributes 518 may be directly aggregated and stored with reference to a unique token 418 without additional processing. In machine learning applications, unprotected attributes may serve as readily available features for model training and prediction. They may be used more freely in data exploration, feature engineering, and model development processes without the need for extensive privacy-preserving techniques.

In some embodiments, the computing system 101 generates, using a token deidentification ruleset, the unique token 418 from a first combination of the subset of protected attributes 514. The token deidentification ruleset 504, for example, may define an arrangement of the first combination of the subset of protected attributes 510. In some examples, the computing system 101 may apply an encryption algorithm 512 to the arrangement of the first combination of the subset of protected attributes 510 to generate the unique token 418.

In some embodiments, the token deidentification ruleset 504 comprises a deidentification scheme leveraged to generate unique token 418 for representing an entity. The token deidentification ruleset 504, for example, may be defined by the computing system 101 to generate a unique token 418 in a reproducible manner. In this manner, the computing system 101 may receive entity attributes 404, generate a unique token 418 from the entity attribute 404, and match the entity attributes 404 to an deidentified file corresponding to the unique token 418. In addition, or alternatively, the token deidentification ruleset 504 may be shared with one or more different data sources to enable the deidentification of the entity attributes 404 before the data is provided to the computing system 101. In any case, the token deidentification ruleset 504 allows the computing system 101 to persist data in a deidentified manner while retaining the capability of adding, removing, and/or otherwise modifying the data based on additional information (e.g., received from the same or one or more different data sources).

The token deidentification ruleset 504 may comprise a set of algorithms and/or procedures within the computing system 101 data processing pipeline. In some examples, the token deidentification ruleset 504 may specify one or more attributes for use as a basis for the generation of the unique token 418, a method in which to arrange the attributes into an attribute sequence 510, and/or cryptographic techniques applied to the attribute sequence 510 to generate the final, reproducible unique token 418. In some examples, the attribute sequence 510 and/or encryption algorithm 512 (and/or the cryptographic keys of the encryption algorithm 512) may be dynamically changed at a predetermined frequency (e.g., 100 days) to prevent malicious actors from recreating a unique token 418. In such a case, unique tokens 418 may be regenerated according to the modifications to the token deidentification ruleset 504.

The attribute sequence 510 may depend on the prediction domain and/or the attributes of the prediction domain. By way of example, in a clinical domain, the attribute sequence 510 may specify an arrangement of the following elements: First Name, Last Name, Middle Name, SSN Last Four, Address Line1, Address Line2, City, Zip, Email, Home Phone, Work Phone, Cell Phone, and/or the like, that may be combined in a specific order and then processed through an encryption algorithm 512 to generate the unique token 418. As another example, in a computer monitoring domain, the attribute sequence 510 may specify an arrangement of the following elements: IP address, Owner Name, Organization, and/or the like, that may be combined in a specific order and then processed through an encryption algorithm 512 to generate the unique token 418.

In some examples, the token deidentification ruleset 504 may comprise one or more preprocessing operations to standardize the attribute sequence 510 before the encryption process. For example, the token deidentification ruleset 504 may apply a text formatting operation (e.g., converting all text to uppercase, removing punctuation), data truncation operation (e.g., using only the first few characters of each field), adding “salt” (random data) to the input before encryption to prevent rainbow table attacks, and/or the like. In addition, or alternatively, the token deidentification ruleset 504 may specify how to handle missing and/or incomplete data, ensuring that a consistent and unique token 418 may be generated even if some input fields are blank. For example, the token deidentification ruleset 504 may specify a default placeholder value entity attributes 404 that are missing from an attribute sequence 510.

In some embodiments, the token deidentification ruleset 504 defines a set of tokenization layers. For example, the token deidentification ruleset 504 may comprise a master token (e.g., using all available identifying information) and/or one or more sub-tokens (e.g., using subsets of the information) to allow for different levels of data linkage while maintaining privacy.

In some embodiments, the encryption algorithm 512 comprises to a reversible and/or irreversible encryption algorithm used in the process of generating unique tokens 418. The encryption algorithm 512, for example, may comprise any encryption technique, such as secure hash functions (e.g., SHA-256), key-based algorithms (e.g., Advanced Encryption Standard (AES), RSA, and Elliptic Curve Cryptography (ECC)), and/or the like, that take an attribute sequence 510 as input and produces ciphertext (e.g., encrypted data) that may be irreversible and/or decrypted back to the attribute sequence 510 using decryption key.

In some embodiments, the resulting unique token 418 is a deidentified unique identifier for an entity that is created for persisting and/or aggregating entity information at the computing system 101 without exposing the entity's sensitive information. The unique token 418 serves as a privacy-preserving way to link different pieces of information about an entity across various data sources or processing stages. In this manner, the unique token 418 may facilitate data sharing and/or integration across different data sources.

In some embodiments, the computing system 101 generates, using a tag deidentification ruleset 506, a nonidentifying attribute tag 516 from a protected attribute 514 of subset of protected attributes. In some example, the tag deidentification ruleset 506 comprises a mapping between the protected attribute 514 and a set of nonidentifying attribute tags corresponding to an independent parameter of the machine learned model.

In some embodiments, the tag deidentification ruleset 506 is a deidentification scheme used to create the nonidentifying attribute tags 516 from protected attributes 514. The tag deidentification ruleset 506 may define a process by which sensitive, identifiable information may be transformed into standardized, non-identifying tags that may be safely used in data analysis and/or machine learning tasks. The tag deidentification ruleset 506 may comprise a set of data transformation rules and/or mapping tables within the computing system 101 data processing pipeline. For example, the tag deidentification ruleset 506 may specifies a transformation operation, such as a binning, categorization, and/or encoding operation, for up to each protected attribute 514 that defines a manner in which the protected attribute 514 may be converted into a nonidentifying attribute tag 516. In some examples, the tag deidentification ruleset 506 may define one or more transformation operations for up to each rare and/or unique attribute value that may potentially identify an entity. This might involve suppressing these values, combining them with other categories, or applying additional perturbation techniques.

By way of example, the tag deidentification ruleset 506 may define a county code and name transformation that replaces specific county information with broader geographic regions and/or population density categories, a gender transformation that maps gender information to standardized categories, an ethnicity transformation that group ethnicity information into broader categories to prevent identification of individuals from small ethnic groups, a marital status transformation that maps marital status information to standardized categories, a preexisting condition transformation that converts specific diagnosis information to binary flags and/or broader disease categories, a social factor transformation that generates composite scores and/or categories from one or more social determinants of health, a birth date transformation that converts a birth date to an age range and/or generational cohort (e.g., assigning all birth dates before August to January 1st of a birth year and/or assigning all birth dates after July to December 31st of the birth year), a deceased date transformation that converts deceased information to time ranges since death or categories, such as “recently deceased” and/or “long-term deceased”, height and weight transformations that converts height and weight information to BMI categories and/or percentile ranges rather than exact measurements, and/or the like.

In some embodiments, the resulting nonidentifying attribute tags 516 comprise a set of standardized entity attributes 404 that record predictive data for an entity without exposing the identifying information underlying the data. In this way, the nonidentifying attribute tags 516 may represent protected attributes 514 in a form that retains their predictive value while minimizing privacy risks.

In some embodiments, the computing system 101, using the tag deidentification ruleset 506 and the token deidentification ruleset 504, stores the subset of unprotected attributes 518 and/or the nonidentifying attribute tag 516 as entity attributes in association with the unique token 418.

FIG. 6 is a dataflow diagram 600 of an explanatory technique for the sentiment-based prediction feedback pipeline in accordance with some embodiments of the present disclosure. A computing system, such as the computing system 101 described herein, may implement the explanatory technique by integrating a machine learning explanatory task to a training stage of the machine learned model 408. For example, during model tuning, a set of training samples 602 may be provided to the machine learned model 408, which may be used to optimize the coefficients, learnable weights, and/or the like, that correspond to an initial set of independent parameters of the machine learned model 408, with respect to a loss function. The machine learned model 408, for example, may be trained using backpropagation of errors as optimized using gradient descent, and/or any other training technique, as described herein.

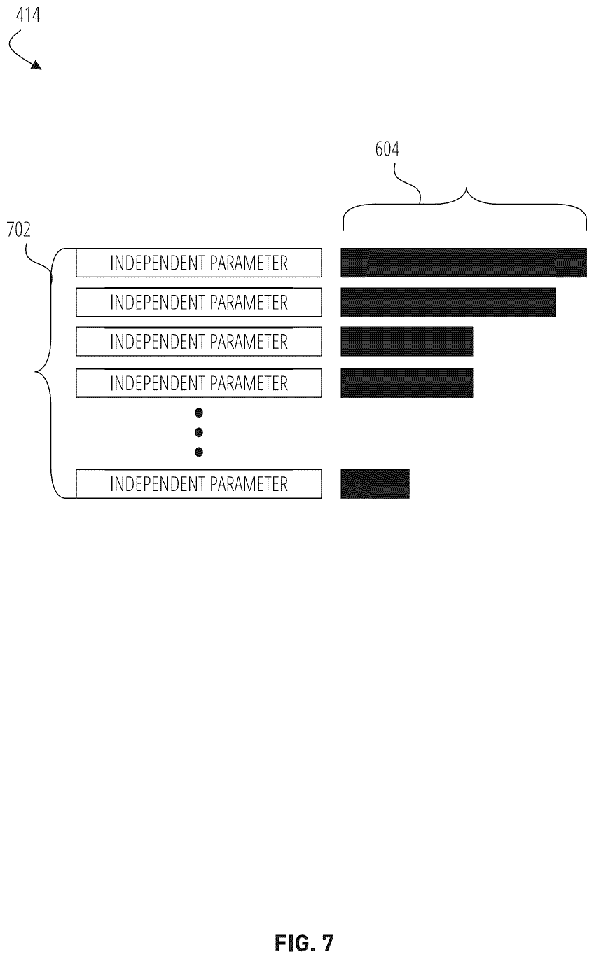

After a first training stage, the computing system 101 may generate a set of contribution scores 604 for up to each of the training samples 602. As described with reference to FIG. 7, the set of contribution scores 604 may comprise an explainable metric, such as a set of SHapley Additive explanations (SHAP) values, for the independent parameters of the machine learned model 408. In some examples, a contribution score 604 for up to each independent parameter may comprise an aggregated contribution score for the independent parameter that is aggregated (e.g., averaged) from up to each of the training samples 602. In this way, a contribution score may reflect an aggregated influence of the independent parameter on a prediction of the machine learned model 408.

Using the contribution scores 604, the machine learned model 408 may prune the independent parameters of the machine learned model 408 to remove cannibalizing parameters 606 (e.g.). The cannibalizing parameters 606, for example, may comprise features with an observed influence on a model prediction that is directly and/or within a degree of similarity to the influence of another parameter. In such a case, the cannibalizing parameters 606 may be pruned to reduce the size of machine learned model 408, among other technical advantages. In some examples, the computing system 101 may perform hyperparameter tuning, using a number of estimators, a maximum depth of each tree within the machine learned model 408, and a minimum number of samples needed to be at a leaf node of each tree. After this, parameters, such as a number of estimators, maximum depth of each tree, and/or minimum number of samples needed to be at a leaf node, may be tuned to reduce overfitting.

In some examples, a set of training iterations may be performed to iteratively prune the independent parameters of the machine learned model 408. In some embodiments, the contribution scores 604 from the last training iteration may be stored as a contribution table 414 in association with the machine learned model 408. In some embodiments, the contribution table 414 defines a ranked list of independent parameters for the machine learned model 408 that is ranked based on the set of contribution scores 604.

FIG. 7 is an operational example of a contribution table 414 in accordance with some embodiments of the present disclosure. In some embodiments, the contribution table 414 comprises a data structure that stores a set of recorded contribution scores 604 for up to each of the independent parameters 702 of the machine learned model. In this manner, the contribution table 414 may serve as a reference for understanding the relative importance of different features in the machine learned model's predictions. In some examples, the contribution table 414 may be implemented as a data structure, such as a database table, a structured file (e.g., CSV, JSON), and/or the like, that maps up to each of the independent parameters 702 to a contribution score 706 derived from at least a portion of the set of training samples. In some examples, the contribution scores 604 may be normalized to a common scale (e.g., 0 to 1 or percentages) to facilitate comparison across different parameters.

In some embodiments, the computing system 101 may generate the contribution table 414 using one or more machine learning explainability techniques, such as SHAP, LIME, integrated gradients, and/or the like, to determine a feature importance for up to each of the independent parameters 702. The computing system 101 may determine the average marginal contribution of a feature across all possible combinations, and store the average marginal contribution as a contribution score 706 within the contribution table 414. In this manner, the contribution table 414 may provide a quick reference for understanding which features are driving the model's predictions, enhancing the interpretability of the model. Moreover, the contribution table 414 may guide feature selection processes for future iterations of the model, helping to focus on the most impactful parameters (e.g., through dynamic query selection).

In some examples, the contribution table 414 may be updated periodically (e.g., every 100 days) as the machine learned model 408 is retrained and/or as new data becomes available. In this way, the contribution table 414 may comprise a set of recorded contribution scores 604 that may account for patterns in the data as the data changes over time.

FIG. 8 is a dataflow diagram 800 of a model training technique for the sentiment-based prediction feedback pipeline in accordance with some embodiments of the present disclosure. A computing system, such as the computing system 101 described herein, may implement the model training technique by integrating model training, data drift detection, and passive feedback into a reinforcement learning pipeline. By doing so, the computing system 101 may leverage a combination of techniques, within a connected pipeline, to improve the accuracy of the machine learned model 408, dynamically handle data drift, and adjust to changes over time without direct external intervention.

In some embodiments, the computing system 101 is trained using reinforcement learning from one or more ground truths observed for the model prediction 410 and/or an updated model prediction. For example, the computing system 101 may receive a feedback input comprising a ground truth response corresponding to the model prediction 410 (and/or an updated model prediction). The computing system 101 may generate a training sample based on the feedback input, the model input 402, and/or one or more sets of subsequent query responses. The computing system 101 may retrain the machine learned model 408 based on the training sample.

In some examples, the computing system 101 may containerize the machine learned model 408 within one or more separate software containers. The software containers, for example, may comprise a processing container 804 and/or a training container 808.

The processing container 804 may be loaded with a trained instantiation of the machine learned model 408, the contribution table 414 for the trained instantiation of the machine learned model 408, and/or a query table (shown in FIG. 4). The processing container 804 may be called to generate a model prediction 410, using a current instantiation of the machine learned model 408, for a unique token 418. To do so, the processing container 804 may pull entity attributes from the data repository 802 (e.g., based on a unique token), generate a model input, and input the model input to the machine learned model 408. The model prediction 410 may be provided as output and/or to a data monitor 806 configured to monitor the performance of the current instantiation of the machine learned model 408.

The training container 808 may be loaded with a trained and/or untrained instantiation of the machine learned model 408. Upon a trigger from the data monitor 806, the training container 808 may pull a set of training samples from the data repository 802 and train, finetune, and/or retrain the machine learned model 408 based on the set of training samples. The trigger, for example, may be issued by the data monitor 806 based a performance drift, data drift, and/or an external stimuli. For example, the data monitor 806 may trigger a retraining operation in response to a deviation (e.g., 30% deviation) between a data distribution of an incoming data and a data distribution of a set of training samples used to train the current instantiation of the machine learned model 408. In response to the deviation, the data monitor 806 may trigger a retraining operation using an updated set of training samples at least partially derived from feedback input to the computing system 101.

In addition, or alternatively, the data monitor 806 may receive the model prediction 410 and/or a feedback input 810 for the model prediction 410. The data monitor 806 may compare the model prediction 410 to the feedback input 810 to determine a performance of the machine learned model 408. In response to a decrease (e.g., a threshold decrease of 5% accuracy) in the performance of the machine learned model 408, the data monitor 806 may trigger a retraining operation using training samples at least partially derived from the feedback input.

In some embodiments, a training sample is a labeled entry for training the machine learned model 408. For example, up to each training sample may comprise of a set of input features (e.g., a model input) paired with the corresponding target output and/or label, providing examples from which the machine learned model 408 may learn patterns and/or relationships. In some examples, the training samples may be manually annotated. In addition, or alternatively, the training samples may be automatically labeled using feedback inputs 810 for model inputs within the data repository 802.

In some embodiments, a feedback input 810 comprise a ground truth for a model input. For example, the feedback input 810 may comprise a real world observation of an entity associated with a model input that validates and/or invalidates a model prediction 410. The feedback input 810 may depend on the prediction domain. For example, in a clinical domain, the feedback input 810 may comprise a measure of medication adherence for an entity that is recorded after a model prediction 410. As another example, in a computer monitoring domain, the feedback input 810 may comprise an overload detection. In any domain, the feedback input 810 may provide ground truth data that may be used to evaluate and/or improve the accuracy of the machine learning model over time. This creates a closed-loop system where predictions are continuously validated against real-world outcomes.

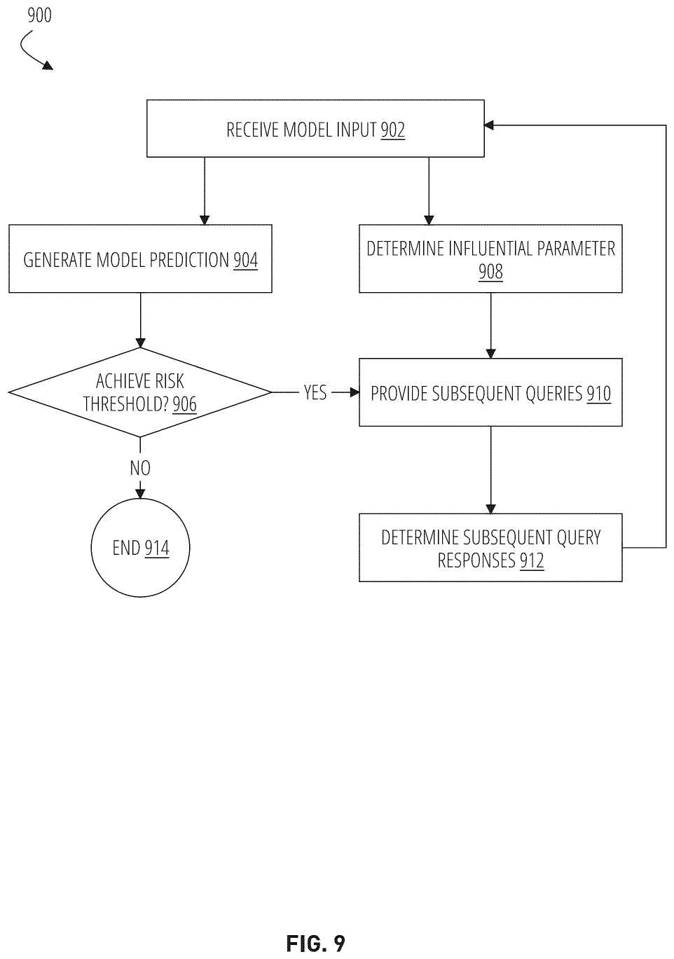

FIG. 9 is a flowchart diagram of sentiment-based prediction process 900 in accordance with some embodiments of the present disclosure. The flowchart diagram depicts a sentiment-based prediction process 900 that improves the accuracy of a machine learned model through a dynamic query feedback loop. The process 900 may be implemented by one or more computing devices, entities, and/or systems described herein. For example, via the various steps/operations of the process 900, the computing system 101 may integrate a connected feature engineering and model explanation task with a machine learned model to enable the dynamic augmentation of a model input. By doing so, the process 900 improves computer functionality by improving the performance (e.g., in terms of accuracy) of a machine learned model with respect to a model input over time.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, receiving a model input. For example, the computing system 101 may receive a model input comprising a set of entity attributes and a set of initial query responses. The set of initial query responses may correspond to (a) a set of initial queries and (b) a first subset of independent parameters of a machine learned model. In some examples, the set of entity attributes may correspond to a third subset of independent parameters of the machine learned model.

In some embodiments, the process 900 comprises, at operation 904, generate a model prediction. For example, the computing system 101 may generate, using the machine learned model, a model prediction based on the model input. The model prediction may comprise a dependent parameter of the machine learned model.

In some embodiments, the process 900 comprises, at operation 906, determining whether the model prediction meets or exceeds a risk threshold. For example, the computing system 101 may determine whether the model prediction meets or exceeds a risk threshold. In response to a determination that the model prediction meets or exceeds the risk threshold, the process 900 may proceed to operation 908, where the computing system 101 determines an influential parameter. Otherwise, the process 900 may END 914. In some embodiments, after the process 900 ends, the computing system 101 may receive a feedback input comprising a ground truth response corresponding to the model prediction (and/or an updated model prediction). The computing system 101 may generate a training sample based on the feedback input, the model input, and/or one or more sets of subsequent query responses. The computing system 101 may retrain the machine learned model based on the training sample.

In some embodiments, the process 900 comprises, at operation 908, determining an influential parameter. For example, the computing system 101 may determine, based on the model prediction, an influential parameter from the first subset of independent parameters for the model prediction. For example, the computing system 101 may determine the influential parameter based on a set of contribution scores defined within a contribution table corresponding to the machine learned model. In some examples, the contribution table 414 may define a ranked list of independent parameters for the machine learned model that is ranked based on the set of contribution scores. The set of contribution scores, for example, may comprise SHAP values, may be determined based on a set of coefficients of the machine learned model 408, and/or the like. In some examples, the contribution table corresponds to a query table that maps the influential parameter to the set of subsequent queries.

In some embodiments, the process 900 comprises, at operation 910, providing one or more subsequent queries. For example, the computing system 101 may provide a set of subsequent queries based on the influential parameter to receive a set of subsequent query responses that correspond to a second subset of independent parameters.

In some examples, the set of entity attributes, the set of initial query responses, and/or the set of subsequent query responses may be stored in association with a unique token corresponding to an entity. For example, the computing system 101 may receive set of raw attributes for the entity. The set of raw attributes may comprise a subset of protected attributes and/or a subset of non-protected attributes. The computing system 101 may generate, using a first deidentification ruleset, the unique token from a first combination of the subset of protected attributes. The token deidentification ruleset, for example, may define an arrangement of the first combination of the subset of protected attributes. In some examples, the computing system 101 may apply an encryption algorithm to the arrangement of the first combination of the subset of protected attributes to generate the unique token.

In addition, or alternatively, the computing system 101 may generate, using a second deidentification ruleset, a nonidentifying attribute tag from a protected attribute of subset of protected attributes. In some example, the tag deidentification ruleset comprises a mapping between the protected attribute and a set of nonidentifying attribute tags corresponding to an independent parameter of the machine learned model.

The computing system 101 may store the subset of non-protected attributes and/or the nonidentifying attribute tag as entity attributes in association with the unique token.

In some embodiments, the process 900 comprises, at operation 912, determining a subsequent query response. For example, the computing system 101 may receive an unstructured transcript, identify the subsequent query within the unstructured transcript, identify an unstructured query response within the unstructured transcript based on a location of the subsequent query, and generate, using the defined response-parameter mapping, the subsequent query response from the unstructured query response. The query response, for example, may comprise a numerical sentiment value within a sentiment range that is defined for the query.

In some embodiments, the process 900 may return to operation 902, where the process may comprise generating, using the machine learned model, an updated model prediction based on the model input and the set of subsequent query responses.

Some techniques of the present disclosure enable the generation of action outputs that may be performed to initiate one or more real world actions to achieve real-world effects. The techniques of the present disclosure may be used, applied, and/or otherwise leveraged to generate model predictions reflective of an anticipated event, such as an adverse medical event, a computer overload, and/or the like. In some examples, the model predictions of the present disclosure may trigger action outputs (e.g., through control instructions) to automate computer recourse allocations, medication applications, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated medical application, such as an insulin injection), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

### Example 1

A computer-implemented method comprising receiving, by one or more processors, a model input comprising a set of entity attributes and a set of initial query responses, wherein the set of initial query responses comprises one or more initial query responses corresponding to (a) a set of initial queries comprising one or more initial queries and (b) a first subset of a set of independent parameters of a machine learned model; generating, by the one or more processors and using the machine learned model, a model prediction based on the model input, wherein the model prediction comprises a dependent parameter of the machine learned model; determining, by the one or more processors and based on the model prediction, an influential parameter, for the model prediction, from the set of independent parameters; providing, by the one or more processors and based on the influential parameter, a set of subsequent queries to receive a set of subsequent query responses that correspond to a second subset of independent parameters of the machine learned model; and generating, by the one or more processors and using the machine learned model, an updated model prediction based on the model input and the set of subsequent query responses.

### Example 2

The computer-implemented method of example 1, wherein the set of entity attributes correspond to a third subset of independent parameters of the machine learned model and the influential parameter is determined from one of the first subset of independent parameters or the third subset of independent parameters.

### Example 3

The computer-implemented method of any of the preceding examples, wherein the set of entity attributes, the set of initial query responses, and the set of subsequent query responses are stored in association with a unique token corresponding to an entity, and the set of entity attributes is stored by receiving a set of raw attributes for the entity, wherein the set of raw attributes comprises a subset of protected attributes and a subset of non-protected attributes; generating, using a first deidentification ruleset, the unique token from a first combination of the subset of protected attributes; generating, using a second deidentification ruleset, a nonidentifying attribute tag from a protected attribute of the subset of protected attributes; and storing the subset of non-protected attributes and the nonidentifying attribute tag as entity attributes in association with the unique token.

### Example 4

The computer-implemented method of example 3, wherein the first deidentification ruleset (i) defines an arrangement of the first combination of the subset of protected attributes and (ii) an encryption algorithm that is applied to the arrangement of the first combination of the subset of protected attributes to generate the unique token.

### Example 5

The computer-implemented method of examples 3 or 4, wherein the second deidentification ruleset comprises a mapping between the protected attribute and a set of nonidentifying attribute tags corresponding to an independent parameter of the machine learned model.

### Example 6

The computer-implemented method of any of the preceding examples, wherein determining the influential parameter comprises, in response to a determination that the model prediction meets or exceeds a risk threshold, determining the influential parameter based on a set of contribution scores defined within a contribution table corresponding to the machine learned model.

### Example 7

The computer-implemented method of example 6, wherein the contribution table defines a ranked list of independent parameters for the machine learned model that is ranked based on the set of contribution scores, and the set of contribution scores comprises a set of SHapley Additive explanations (SHAP) values.

### Example 8

The computer-implemented method of examples 6 of 7, wherein the contribution table corresponds to a query table that maps the influential parameter to the set of subsequent queries.

### Example 9

The computer-implemented method of any of the preceding examples, wherein the set of initial queries is a portion of a query superset, a query response to a query of the query superset corresponds to an independent parameter of the machine learned model, and the query response is determined by receiving an unstructured transcript; identifying the query within the unstructured transcript; identifying an unstructured query response within the unstructured transcript based on a location of the query; and generating, using a defined response-parameter mapping, the query response from the unstructured query response, wherein the query response comprises a numerical sentiment value within a sentiment range that is defined for the query.

### Example 10

The computer-implemented method of any of the preceding examples, further comprising receiving a feedback input comprising a ground truth response corresponding to the updated model prediction; generating a training sample based on the feedback input, the model input, and the set of subsequent query responses; and retraining the machine learned model based on the training sample.

### Example 11

A system comprising one or more processors; and one or more memories storing processor-executable instructions that, when executed by the one or more processors, cause the one or more processors to perform operations comprising receiving a model input comprising a set of entity attributes and a set of initial query responses, wherein the set of initial query responses comprises one or more initial query responses corresponding to (a) a set of initial queries comprising one or more initial queries and (b) a first subset of independent parameters of a machine learned model; generating, using the machine learned model, a model prediction based on the model input, wherein the model prediction comprises a dependent parameter of the machine learned model; determining, based on the model prediction, an influential parameter for the model prediction; providing, based on the influential parameter, a set of subsequent queries to receive a set of subsequent query responses that correspond to a second subset of independent parameters; and generating, using the machine learned model, an updated model prediction based on the model input and the set of subsequent query responses.

### Example 12

The system of example 11, wherein the set of entity attributes correspond to a third subset of independent parameters of the machine learned model.

### Example 13

The system of examples 11 or 12, wherein the set of entity attributes, the set of initial query responses, and the set of subsequent query responses are stored in association with a unique token corresponding to an entity, and the set of entity attributes are stored by receiving a set of raw attributes for the entity, wherein the set of raw attributes comprises a subset of protected attributes and a subset of non-protected attributes; generating, using a first deidentification ruleset, the unique token from a first combination of the subset of protected attributes; generating, using a second deidentification ruleset, a nonidentifying attribute tag from a protected attribute of the subset of protected attributes; and storing the subset of non-protected attributes and the nonidentifying attribute tag as entity attributes in association with the unique token.

### Example 14

The system of example 13, wherein the first deidentification ruleset (i) defines an arrangement of the first combination of the subset of protected attributes and (ii) an encryption algorithm that is applied to the arrangement of the first combination of the subset of protected attributes to generate the unique token.

### Example 15

The system of examples 13 or 14, wherein the second deidentification ruleset comprises a mapping between the protected attribute and a set of nonidentifying attribute tags corresponding to an independent parameter of the machine learned model.

### Example 16

The system of any of examples 11 through 15, wherein (i) determining the influential parameter comprises, in response to a determination that the model prediction meets or exceeds a risk threshold, determining the influential parameter based on a set of contribution scores defined within a contribution table corresponding to the machine learned model, (ii) the contribution table defines a ranked list of independent parameters for the machine learned model that is ranked based on the set of contribution scores, and the set of contribution scores comprises a set of SHapley Additive explanations (SHAP) values, and (iii) the contribution table corresponds to a query table that maps the influential parameter to the set of subsequent queries.

### Example 17

One or more non-transitory computer-readable media storing processor-executable instructions that, when executed by one or more processors, cause the one or more processors to perform operations comprising receiving a model input comprising a set of entity attributes and a set of initial query responses, wherein the set of initial query responses comprises one or more initial query responses corresponding to (a) a set of initial queries comprising one or more initial queries and (b) a first subset of independent parameters of a machine learned model; generating, using the machine learned model, a model prediction based on the model input, wherein the model prediction comprises a dependent parameter of the machine learned model; determining, based on the model prediction, an influential parameter for the model prediction; providing, based on the influential parameter, a set of subsequent queries to receive a set of subsequent query responses that correspond to a second subset of independent parameters; and generating, using the machine learned model, an updated model prediction based on the model input and the set of subsequent query responses.

### Example 18

The one or more non-transitory computer-readable media of example 17, wherein (i) determining the influential parameter comprises, in response to a determination that the model prediction meets or exceeds a risk threshold, determining the influential parameter based on a set of contribution scores defined within a contribution table corresponding to the machine learned model, (ii) the contribution table defines a ranked list of independent parameters for the machine learned model that is ranked based on the set of contribution scores, and the set of contribution scores comprises a set of SHapley Additive explanations (SHAP) values, and (iii) the contribution table corresponds to a query table that maps the influential parameter to the set of subsequent queries.

### Example 19

The one or more non-transitory computer-readable media of examples 17 or 18, wherein the set of initial queries is a portion of a query superset, a query response to a query of the query superset corresponds to an independent parameter of the machine learned model, and the query response is determined by receiving an unstructured transcript; identifying the query within the unstructured transcript; identifying an unstructured query response within the unstructured transcript based on a location of the query; and generating, using a defined response-parameter mapping, the query response from the unstructured query response, wherein the query response comprises a numerical sentiment value within a sentiment range that is defined for the query.

### Example 20

The one or more non-transitory computer-readable media of any of examples 17 through 19, wherein the operations further comprise receiving a feedback input comprising a ground truth response corresponding to the updated model prediction; generating a training sample based on the feedback input, the model input, and the set of subsequent query responses; and retraining the machine learned model based on the training sample.

### Example 21

The computer-implemented method of example 1, wherein the method further comprises training the machine learned model.

### Example 22

The computer-implemented method of example 21, wherein the training is performed by the one or more processors.

### Example 23

The computer-implemented method of example 21, wherein the one or more processors are comprised in a first computing entity; and the training is performed by one or more other processors comprised in a second computing entity.

### Example 24

The computing system of example 11, wherein the one or more processors are further configured to train the machine learned model.

### Example 25

The computing system of example 24, wherein the one or more processors are comprised in a first computing entity; and the machine learned model is trained by one or more other processors comprised in a second computing entity.

### Example 26

The one or more non-transitory computer-readable storage media of example 17, wherein the instructions further cause the one or more processors to train the machine learned model.

### Example 27

The one or more non-transitory computer-readable storage media of example 26, wherein the one or more processors are comprised in a first computing entity; and the machine learned model is trained by one or more other processors comprised in a second computing entity.

What is claimed is:

1. A computer-implemented method comprising:
receiving, by one or more processors, a model input comprising a set of entity attributes and a set of initial query responses, wherein the set of initial query responses comprises one or more initial query responses corresponding to (a) a set of initial queries comprising one or more initial queries and (b) a first subset of a set of independent parameters of a machine learned model;
generating, by the one or more processors and using the machine learned model, a model prediction based on the model input, wherein the model prediction comprises a dependent parameter of the machine learned model;
determining, by the one or more processors and based on the model prediction, an influential parameter, for the model prediction, from the set of independent parameters;
providing, by the one or more processors and based on the influential parameter, a set of subsequent queries to receive a set of subsequent query responses that correspond to a second subset of independent parameters of the machine learned model; and
generating, by the one or more processors and using the machine learned model, an updated model prediction based on the model input and the set of subsequent query responses.

2. The computer-implemented method of claim 1, wherein the set of entity attributes correspond to a third subset of independent parameters of the machine learned model and the influential parameter is determined from one of the first subset of independent parameters or the third subset of independent parameters.

3. The computer-implemented method of claim 1, wherein the set of entity attributes, the set of initial query responses, and the set of subsequent query responses are stored in association with a unique token corresponding to an entity, and the set of entity attributes is stored by:
receiving a set of raw attributes for the entity, wherein the set of raw attributes comprises a subset of protected attributes and a subset of non-protected attributes;
generating, using a first deidentification ruleset, the unique token from a first combination of the subset of protected attributes;
generating, using a second deidentification ruleset, a nonidentifying attribute tag from a protected attribute of the subset of protected attributes; and
storing the subset of non-protected attributes and the nonidentifying attribute tag as entity attributes in association with the unique token.

4. The computer-implemented method of claim 3, wherein the first deidentification ruleset (i) defines an arrangement of the first combination of the subset of protected attributes and (ii) an encryption algorithm that is applied to the arrangement of the first combination of the subset of protected attributes to generate the unique token.

5. The computer-implemented method of claim 3, wherein the second deidentification ruleset comprises a mapping between the protected attribute and a set of nonidentifying attribute tags corresponding to an independent parameter of the machine learned model.

6. The computer-implemented method of claim 1, wherein determining the influential parameter comprises, in response to a determination that the model prediction meets or exceeds a risk threshold, determining the influential parameter based on a set of contribution scores defined within a contribution table corresponding to the machine learned model.

7. The computer-implemented method of claim 6, wherein the contribution table defines a ranked list of independent parameters for the machine learned model that is ranked based on the set of contribution scores, and the set of contribution scores comprises a set of SHapley Additive explanations (SHAP) values.

8. The computer-implemented method of claim 6, wherein the contribution table corresponds to a query table that maps the influential parameter to the set of subsequent queries.

9. The computer-implemented method of claim 1, wherein the set of initial queries is a portion of a query superset, a query response to a query of the query superset corresponds to an independent parameter of the machine learned model, and the query response is determined by:
receiving an unstructured transcript;
identifying the query within the unstructured transcript;
identifying an unstructured query response within the unstructured transcript based on a location of the query; and
generating, using a defined response-parameter mapping, the query response from the unstructured query response, wherein the query response comprises a numerical sentiment value within a sentiment range that is defined for the query.

10. The computer-implemented method of claim 1, further comprising:
receiving a feedback input comprising a ground truth response corresponding to the updated model prediction;
generating a training sample based on the feedback input, the model input, and the set of subsequent query responses; and
retraining the machine learned model based on the training sample.

11. A system comprising:
one or more processors; and
one or more memories storing processor-executable instructions that, when executed by the one or more processors, cause the one or more processors to perform operations comprising:
receiving a model input comprising a set of entity attributes and a set of initial query responses, wherein the set of initial query responses comprises one or more initial query responses corresponding to (a) a set of initial queries comprising one or more initial queries and (b) a first subset of independent parameters of a machine learned model;
generating, using the machine learned model, a model prediction based on the model input, wherein the model prediction comprises a dependent parameter of the machine learned model;
determining, based on the model prediction, an influential parameter for the model prediction;
providing, based on the influential parameter, a set of subsequent queries to receive a set of subsequent query responses that correspond to a second subset of independent parameters; and
generating, using the machine learned model, an updated model prediction based on the model input and the set of subsequent query responses.

12. The system of claim 11, wherein the set of entity attributes correspond to a third subset of independent parameters of the machine learned model.

13. The system of claim 11, wherein the set of entity attributes, the set of initial query responses, and the set of subsequent query responses are stored in association with a unique token corresponding to an entity, and the set of entity attributes are stored by:
receiving a set of raw attributes for the entity, wherein the set of raw attributes comprises a subset of protected attributes and a subset of non-protected attributes;
generating, using a first deidentification ruleset, the unique token from a first combination of the subset of protected attributes;
generating, using a second deidentification ruleset, a nonidentifying attribute tag from a protected attribute of the subset of protected attributes; and
storing the subset of non-protected attributes and the nonidentifying attribute tag as entity attributes in association with the unique token.

14. The system of claim 13, wherein the first deidentification ruleset (i) defines an arrangement of the first combination of the subset of protected attributes and (ii) an encryption algorithm that is applied to the arrangement of the first combination of the subset of protected attributes to generate the unique token.

15. The system of claim 13, wherein the second deidentification ruleset comprises a mapping between the protected attribute and a set of nonidentifying attribute tags corresponding to an independent parameter of the machine learned model.

16. The system of claim 11, wherein:
(i) determining the influential parameter comprises, in response to a determination that the model prediction meets or exceeds a risk threshold, determining the influential parameter based on a set of contribution scores defined within a contribution table corresponding to the machine learned model,
(ii) the contribution table defines a ranked list of independent parameters for the machine learned model that is ranked based on the set of contribution scores, and the set of contribution scores comprises a set of SHapley Additive explanations (SHAP) values, and
(iii) the contribution table corresponds to a query table that maps the influential parameter to the set of subsequent queries.

17. One or more non-transitory computer-readable media storing processor-executable instructions that, when executed by one or more processors, cause the one or more processors to perform operations comprising:
receiving a model input comprising a set of entity attributes and a set of initial query responses, wherein the set of initial query responses comprises one or more initial query responses corresponding to (a) a set of initial queries comprising one or more initial queries and (b) a first subset of independent parameters of a machine learned model;
generating, using the machine learned model, a model prediction based on the model input, wherein the model prediction comprises a dependent parameter of the machine learned model;
determining, based on the model prediction, an influential parameter for the model prediction;
providing, based on the influential parameter, a set of subsequent queries to receive a set of subsequent query responses that correspond to a second subset of independent parameters; and
generating, using the machine learned model, an updated model prediction based on the model input and the set of subsequent query responses.

18. The one or more non-transitory computer-readable media of claim 17, wherein:
(i) determining the influential parameter comprises, in response to a determination that the model prediction meets or exceeds a risk threshold, determining the influential parameter based on a set of contribution scores defined within a contribution table corresponding to the machine learned model,
(ii) the contribution table defines a ranked list of independent parameters for the machine learned model that is ranked based on the set of contribution scores, and the set of contribution scores comprises a set of SHapley Additive explanations (SHAP) values, and
(iii) the contribution table corresponds to a query table that maps the influential parameter to the set of subsequent queries.

19. The one or more non-transitory computer-readable media of claim 17, wherein the set of initial queries is a portion of a query superset, a query response to a query of the query superset corresponds to an independent parameter of the machine learned model, and the query response is determined by:
receiving an unstructured transcript;
identifying the query within the unstructured transcript;
identifying an unstructured query response within the unstructured transcript based on a location of the query; and
generating, using a defined response-parameter mapping, the query response from the unstructured query response, wherein the query response comprises a numerical sentiment value within a sentiment range that is defined for the query.

20. The one or more non-transitory computer-readable media of claim 17, wherein the operations further comprise:
receiving a feedback input comprising a ground truth response corresponding to the updated model prediction;
generating a training sample based on the feedback input, the model input, and the set of subsequent query responses; and
retraining the machine learned model based on the training sample.
